(19) United States
(12) Patent Application Publication
(10) Pub. No.: US 2011/0000546 A1
(43) Pub. Date: Jan. 6, 2011

(54) Method for transportation of cng or oil

(76) Inventor: Benton Frederick Baugh, Houston, TX (US)

Correspondence Address: BENTON F. BAUGH, 19210 Cohen Green Lane, HOUSTON, TX, 77094, US

(21) Appl. No.: 12/454,356

(22) Filed: May 18, 2009

(51) Int. Cl. F17D 3/00

(52) U.S. Cl. 137/1

(57) ABSTRACT

The method of transporting natural gas from a subsea location to shore by providing a subsea tanker with a storage tank which is a balloon, a loading tower for the docking of the subsea tanker at a certain depth, loading the storage tank with natural gas at the loading tower, transporting the gas subsea at the same depth, providing a sales tower for the docking of said subsea tanker at a the same depth and venting said natural gas into a pipeline for delivery shore.

### CROSS-REFERENCE TO RELATED APPLICATION

N/A

### STATEMENT REGARDING FEDERALLY SPONSORED RESEARCH OR DEVELOPMENT

N/A

### INCORPORATION-BY-REFERENCE OF MATERIAL SUBMITTED ON A COMPACT DISK

N/A

### BACKGROUND OF THE INVENTION

The field of this invention of that of the delivery of natural gas from a location offshore to a market on land, where the distances are not amenable to the laying of pipelines. This market is presently served by compressed natural gas ships or the gas is called stranded or is simply flared because it is not economic to produce by either pipelines or compressed natural gas ships.

Compressed natural gas ships are constructed of a series of high pressure tanks which attempt to transport gas economically by transporting a maximum amount of gas by increasing the density by a combination of pressure (i.e. 1000 p.s.i.) and reduced temperature (i.e. −40 degrees F. or C.).

As one might imagine building a ship loaded with 1000 p.s.i. tanks and refrigerating gas to −40 degrees F. or C. is expensive.

As the ships for transport are very expensive, the compressed natural gas must be immediately offloaded into comparable expensive receiving facilities. The cost of implementing a system to do this will cost something in excess of 1 billion dollars.

There are hundreds of islands especially, in the Indonesian area, which need to have a ready power supply to support development, but which cannot support a billion dollar investment. They would be immensely assisted by a ready supply of energy which could be easily turned into heat and electricity.

### BRIEF SUMMARY OF THE INVENTION

The object of this invention is to provide a method of transporting natural gas without the expense of constructing high pressure tanks.

A second object of the present invention is to provide a method of transporting gas without the expense of refrigerating the gas to subzero temperatures.

A third object of the present invention is to provide a method of transporting gas without the expense of receiving facilities.

### BRIEF DESCRIPTION OF SEVERAL VIEWS OF THE DRAWINGS

FIG. 1 is a view of the system of this invention in which a subsea tanker is starting to be loaded on a loading stand.

FIG. 2 is a view of the system of this invention in which a subsea tanker is fully loaded on the loading stand.

FIG. 3 is a view of the system of this invention in which the subsea tanker has left the loading stand and is being transported to the delivery location.

FIG. 4 is a view of the system of this invention in which the subsea tanker is being docked at the delivery location.

FIG. 5 is a view of the system of this invention in which the subsea tanker is docked at the delivery location and is supplying natural gas to the shore.

### DETAILED DESCRIPTION OF THE INVENTION

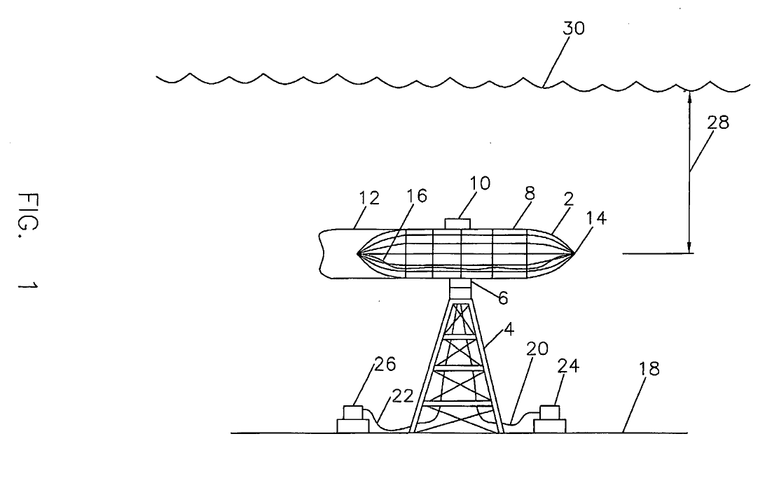

FIG. 1 shows a subsea tanker 2 landed on a loading tower 4 by a swiveling connector 6. The subsea tanker 2 comprises a steel cage frame 8, an upper connector 10, a tail fin 12 for keeping the nose 14 pointed into the current and a gas bag 16 which is shown to be deflated at this time. Loading tower 4 is landed on the seafloor 18 and has supply pipelines 20 and 22 from subsea facilities 24 and 26 respectively. The steel frame cage 8 can be simply a capture for the gas bag 16 or can provide some restraint for the gas bag 16 to allow an increase in the pressure of gas in the gas bag for greater carrying capacity.

The subsea tanker 2 is a depth 28 below the surface of the ocean 30. The gas bag 16 is not a pressure vessel, but rather a rubber sack. If the depth 28 is approximately 537 feet and the pressure gradient of seawater is 0.465 p.s.i./ft. The pressure of any gas in the bag is approximately 250 p.s.i.

Delivery of gas to a home is 0.2 p.s.i., so one cubic foot of gas in the subsea tanker at a 250 foot depth will yield (250+14.7)/(0.2+14.7)=17.76 cubic feet of gas to the end user.

It is important that the subsea tanker be kept near the depth 28 so that when the gas is charged in the gas bag 16, it will remain at that size. When the gas bag if fully charged, it is important that the subsea tanker 2 remains heavy in water and stays at that depth.

It should be noted that as the subsea tanker 2 is mostly a steel frame 8, a gas bag 16, and a couple of connectors it is relatively inexpensive in comparison to alternate styles of manufacture.

If it is allowed to go to a greater depth, it will further compress the gas, with the only actual effect being that it will become heavier. If it is allowed to come closer to the surface, the gas bag can expand and burst the steel cage frame 8. In doing that the gas load will be lost and the damaged subsea tanker 2 will sink to the bottom of the ocean.

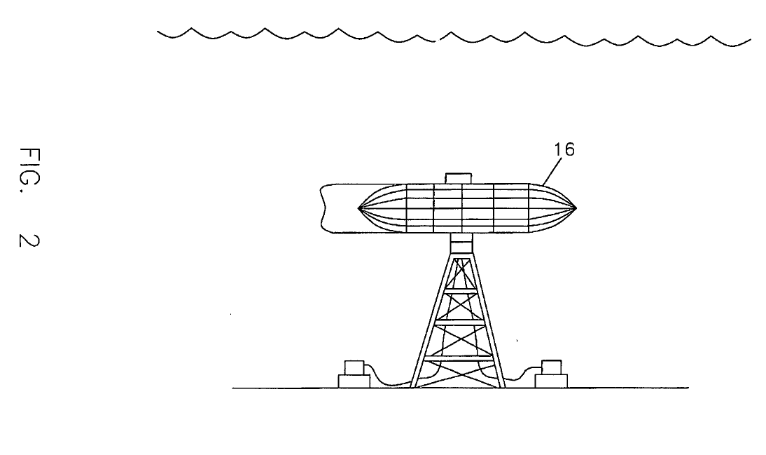

Referring now to FIG. 2, the gas bag 16 is fully charged and conforms closely to the steel cage frame 8. It is ready to be moved to the sales location.

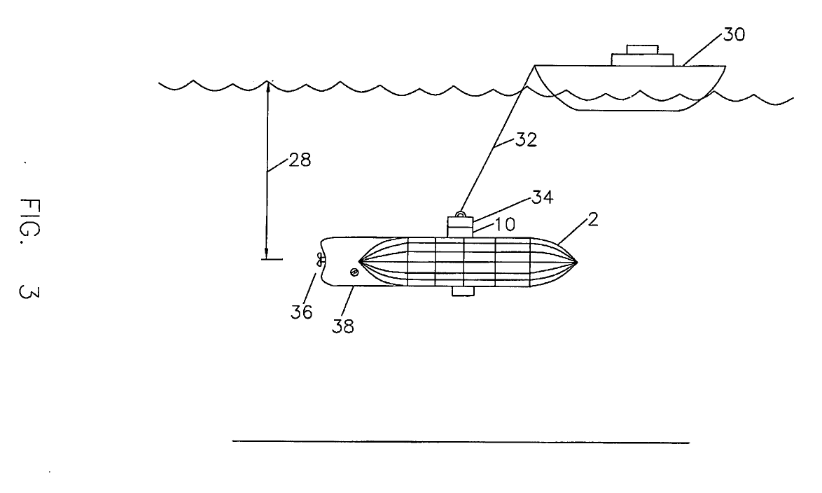

Referring now to FIG. 3, a vessel of opportunity 30 is attached to the subsea tanker 2 by means of a cable 32 and a connector 34 which is connected to the upper connector 10. It remains at the depth 28. The term vessel of opportunity is used as a wide variety of vessels will do this task, down to potentially a tug boat. It can potentially be the lowest cost vessel which can operate in the area.

Propellers 36 and thrusters 38 can be provided on the subsea tanker 2 to move the subsea tanker 2 through the water and assist in docking operations.

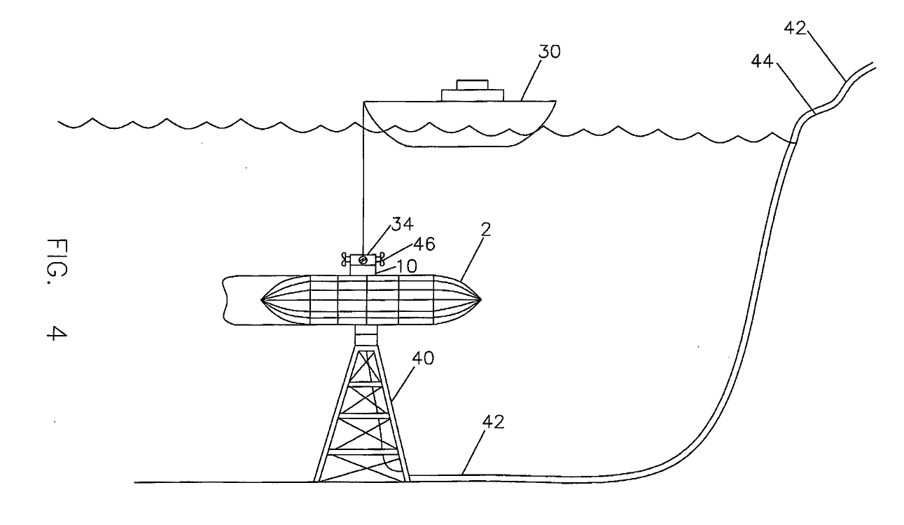

Referring now to FIG. 4, the vessel of opportunity 30 has docked the subsea tanker 2 on a sales tower 40. Propellers 46 can be provided on the connector 34 rather than on the subsea tanker 2 itself. These can provide the power to move the subsea tanker 2 without complicating the connection of connector 34 to upper connector 10. This style construction will also assist the alignment of connector 34 with upper connector 10 when the attachment is made.

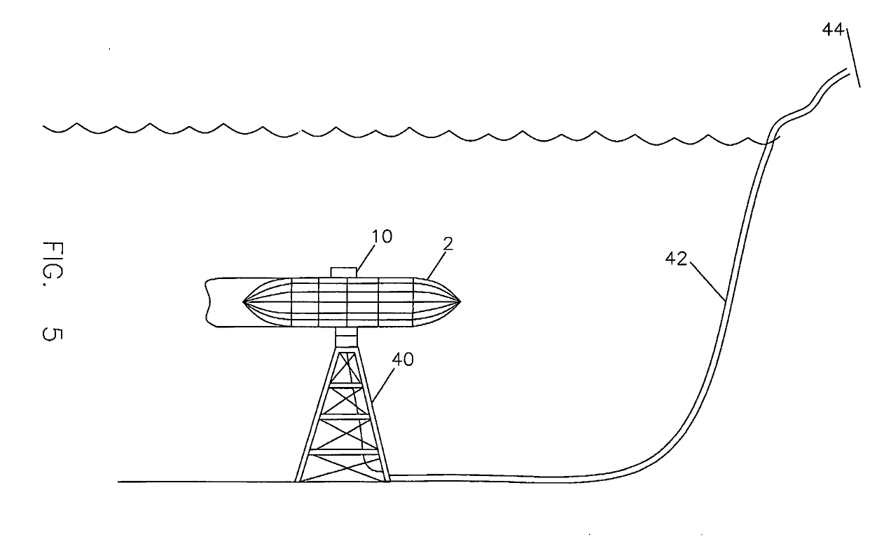

Referring now to FIG. 5, the vessel of opportunity 30 has left and the subsea tanker 2 will remain docked on the top of the sales tower 40 until the gas is depleted. The low cost of the subsea tanker make it possible for it to be stationed as a supply tank. The sales tower 40 has a pipeline 42 going up to the shore 44 and onto useful purposes. When the natural gas is depleted from the gas bag 16, a vessel of opportunity will reattach to the upper connector 10 on the top of the subsea tanker 2 and the process will begin again.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

### SEQUENCE LISTING

N/A

1. A method of transporting natural gas or oil from a subsea location to shore comprising
providing a subsea tanker comprising a storage tank which is not rigid,
providing a loading tower for the docking of said subsea tanker at a first depth,
loading said storage tank with natural gas at said loading tower,
providing a sales tower for the docking of said subsea tanker at a depth proximate said first depth,
transporting said subsea tanker from said loading tower to said sales tower with said subsea tanker remaining proximate said first depth during transit, and
venting said natural gas into a pipeline for delivery shore.

2. The method of claim 1, wherein said subsea tanker is held at said first depth by the connector which is connected to a vessel on the surface of the water.

3. The method of claim 2, wherein said connector provides propulsion to move said subsea tanker.

4. The method of claim 1, wherein said subsea tanker lands on said loading tower with a connector proximate the center of said subsea tower.

5. The method of claim 4, wherein said connector includes a swivel.

6. The method of claim 5, wherein said subsea tanker has a tail fin which cooperates with said tail fin to keep the subsea tanker pointed into the ocean currents.

7. The method of claim 1, wherein said sales tower is connected to a pipeline to a nearby shore.

8. The method of claim 1, wherein said subsea tanker is self propelled.

9. The method of transporting natural gas or oil from a first subsea location to a second subsea location, comprising
docking a flexible tank at a first subsea docking station at a depth,
loading said flexible tank with said natural gas or oil,
moving said flexible tank from said first subsea docking station to a second subsea docking station while maintaining said flexible tank at approximately said depth,
unloading said oil or gas from said flexible tank.

10. The method of claim 9, wherein said subsea tanker is held at said first depth by the connector which is connected to a vessel on the surface of the water.

11. The method of claim 10, wherein said connector provides propulsion to move said subsea tanker.

12. The method of claim 9, wherein said subsea tanker lands on said loading tower with a connector proximate the center of said subsea tower.

13. The method of claim 12, wherein said connector includes a swivel.

14. The method of claim 13, wherein said subsea tanker has a tail fin which cooperates with said tail fin to keep the subsea tanker pointed into the ocean currents.

15. The method of claim 9, wherein said sales tower is connected to a pipeline to a nearby shore.

16. The method of claim 9, wherein said subsea tanker is self propelled.

17. The method of transporting natural gas or oil from a first subsea location to a second subsea location, comprising
docking a tank at a first subsea docking station at a depth,
loading said tank with said natural gas or oil,
moving said tank from said first subsea docking station to a second subsea docking station,
unloading said oil or gas from said tank.

18. The method of claim 17, wherein said tank is flexible.

19. The method of claim 17, wherein said tank is maintained at approximately at the same depth.

20. The method of claim 17, wherein said natural gas or oil is unloaded into a pipeline which goes to a shore.
